(19) United States
(12) Patent Application Publication
(10) Pub. No.: US 2003/0037187 A1
(43) Pub. Date: Feb. 20, 2003

(54) Method and apparatus for data storage information gathering

(76) Inventors: Walter H. Hinton, Westminster, CO (US); Garry T. Anderson, Westminster, CO (US); Richard D. Rector, Erie, CO (US); Bienvenido G. Reyes JR., Longmont, CO (US); Gary W. Ritzer, Lafayette, CO (US); Arthur A. Scrimo, Northglenn, CO (US); Eric D. West, Lakewood, CO (US)

Correspondence Address: Kent A. Lembke, Esq., Hogan & Hartson, LLP, Suite 1500, 1200 17th Street, Denver, CO, 80202, US

(21) Appl. No.: 10/216,941

(22) Filed: Aug. 12, 2002

Related U.S. Application Data
(60) Provisional application No. 60/312,162, filed on Aug. 14, 2001.

(51) Int. Cl. G06F 3/00

(52) U.S. Cl. 710/1

(57) ABSTRACT

A method and system for characterizing data storage usage by a host in a data storage system that provides a host-specific access area in a storage device. Access is gained to the access area and blocks of data from the access area are retrieved and stored in buffers. The stored data is classified as allocated as an organized data structured defined by a particular file system or non-typical system. The classifying includes sequentially mapping the data into file system data structures until a match is obtained and then the mapped data structure is stored. The match is verified by retrieving expected values for a file system and comparing the mapped values with the expected values. The mapped data is used to determine host storage information, such as number of blocks, number of the used data blocks, free space, number of files, location of files, and size of files.

### CROSS REFERENCE TO RELATED APPLICATIONS

This application claims the benefit of U.S. Provisional Application No. 60/312,162, filed Aug. 14, 2001, the disclosure of which is herein specifically incorporated in its entirety by this reference.

### BACKGROUND OF THE INVENTION

1. Field of the Invention

The present invention relates, in general, to efficient use of data storage systems and, more particularly, to software, systems and methods for accessing data storage devices and systems to determine file systems or other data structures being utilized by host or client computers in a storage device or system and to one or more data storage use characteristics, such as storage capacity, storage availability, location of files and data, and other useful data storage information.

2. Relevant Background

The demand for cost efficient, effectively managed, and secure data storage is continuing to grow. In the data storage industry, this growing market has led to a rapid expansion of data storage and data storage management and monitoring as a service with the storage utility market expected to soon exceed $6 billion per year. Enterprises and other clients of these managed storage service providers are looking for help with monitoring and managing the health, security, performance, and capacity of their often heterogeneous storage environment (e.g., local or remote tape, disk, or combination storage systems utilizing storage area network (SAN), network attached storage (NAS), Fibre channel networks, and other storage arrangements). The clients require help in proactively managing their data structures, selecting storage systems, better utilizing storage capacity, and controlling capital expenditures. Because of the growing complexity of storage systems and growing demand for storage services, the data storage industry is continuously searching for more effective methods of characterizing existing customer storage environments, of collecting storage system information, and of reporting such information to the expanding customer base.

In general, data storage involves the organization of storage devices, such as tape libraries, disks, and disk arrays, into logical groupings to achieve various performance and availability characteristics. For example, the disks may be arranged to create individual volumes or concatenations of volumes, mirror sets or stripes of mirror sets, or even redundant arrays of independent disks (RAID). The computer system or network, typically includes a host or client computer operating one or more applications (e.g., database applications, data processing applications, and the like) coupled to a storage controller in a data storage device or system (e.g., a disk array). An operating system running on the host computer functionally organizes and controls data flow and storage in the computer system by invoking input/output (I/O) operations in support of software processes or applications executing on the host computer.

The operating system typically divides management of the storage devices or systems into individual components including an I/O system and a file system (or other data organizer such as a database management system). The I/O system provides an efficient mode of communication between the computer and the disks that allows programs and data to be entered into the memory of the computer for processing. The file system arranges the information on the storage devices into organized data structures and provides algorithms that implement properties of the desired storage architecture. A well-engineered file system or data organizer can improve application and storage performance with data allocation techniques, I/O efficiency, recovery from system crashes, dynamic utility functions, frozen image techniques, and other functions.

To effectively monitor and manage a customer's data storage environment, it is important for a managed storage service provider to be able to be able to identify and characterize the file system or other organized data structure being utilized by the customer on managed storage systems. Without this information, it is difficult to determine storage information, such as file location, data storage capacity, and other data structure information, because most file systems and other data structures call for the organization of data and usage of storage space to be handled in different ways. For example, conventional Unix file systems manage storage space in fixed-size allocation units or file system blocks that each consist of a sequence of disk or volume blocks. On-disk data structures called inodes are used to describe each file by including metadata about the file and block pointers that indicate the location of the file's data on the data storage device. In contrast, some file systems use extent-based space allocation to reduce or eliminate I/O overhead. Such file systems allocate storage space in variable-length extents of one or more file system blocks with the file's block map again kept in inodes. Without knowledge of the specific file system or data structure being implemented by the customer or host computer, the managed storage service provider may be unable to accurately monitor and manage the use of the storage device by the customer or host.

Adding to the monitoring and managing problem is the large number and variety of file systems and data structure methods. Typically, each operating system and/or data storage vendor utilizes a unique file system or storage method. For example, Microsoft Corporation developed NT file system (NTFS) for use with its Windows™ NT operating system in an attempt to improve reliability by utilizing a master file table (MFT) that consists of an array of entries (one per file) with attributes for the file, keeping a transaction log to recover from disk failures, controlling access to files with permissions, and allowing a file to be spread over several physical disks. Operating systems may also be configured to use file allocation tables (e.g., FAT32 is a file system implemented by Windows™ 95 and Windows™ 98 operating systems). In FAT file systems, a table is used to keep track of all of pieces of fragmented files on one or more disks of a storage device or system. Even FAT file systems can vary in practice such as by the number of bits used to address file pieces or clusters in attempts to support different sized disks and to enhance storage efficiency. Some operating systems utilize a journaled file system (JFS) that maintains a log or journal of what activity has taken place in data areas of a disk to allow data to be recovered after a crash by use of metadata and bit maps in the journal. Other file systems with differing methods include UFS utilized by many Sun Microsystems, Inc. operating systems, extended file systems (Ext, Ext2, Ext3) implemented in Linux systems, and VxFS developed by Veritas, Inc. and implemented by a number of operating systems. Similarly, the number of other data structures, such as databases including those provided by Oracle, Microsoft, Informix, Sybase, and others, are numerous with a variety of differing data storage techniques that affect the use and configuration of a data storage device or system.

Hence, there remains a need for an improved method and system for gathering data storage information for host or client computers that is preferably non-intrusive to the host or client computer, that is capable of identifying the file system or other organized data structures used by the host or client computer in a data storage system, and is able to effectively interpret and report data structure and system information.

### SUMMARY OF THE INVENTION

Briefly, the present invention provides a method and system for monitoring and characterizing data storage usage by one or more computer devices, e.g., host, client, and other devices, in a data storage system that provides the computer device with a device-specific access area within one or more storage devices for storing data. The method involves obtaining access to the device-specific access area in the storage device, such as by requesting permission from a storage controller in the data storage system. The method continues with retrieving, such as with a low-level read or operating system call, blocks of data (e.g., raw data structure data) from the access area and storing the raw data structure data in buffers for later processing. The stored data is then classified as being organized or allocated as an organized data structured defined by one of a set of file systems or a set of non-typical file systems (such as a database defined by a database management system).

The classifying includes sequentially casting or mapping the raw data into file system data structures until a match or well-formed data structure is obtained and then the mapped data structure is stored in memory for additional processing. The match is often verified once a preliminary match for a file system is achieved by retrieving expected or known values for that file system (e.g., values or numbers consistently found in structures formed to the file system) and comparing the mapped values with the expected values. Once the retrieved data is classified (and/or mapped), the method continues with using the classified data to determine a set of host storage information, such as number of data blocks, number of the data blocks in use, storage capacity, storage free space, number of files, location of files, size of individual files, and contents of the individual files. The method may further include generating a report based on the host storage information and providing the report to a host or other requesting entity. The method can be performed in a non-intrusive manner and typically is performed concurrently for a plurality of host devices and data storage systems to effectively monitor host data storage usage in data storage systems or networks.

### BRIEF DESCRIPTION OF THE DRAWINGS

FIG. 1 illustrates in block diagram form a managed storage system according to the present invention that implements a storage monitoring system to gather and process host computer data storage information;

FIG. 2 illustrates in block diagram form an alternative managed storage system of the invention in which a storage monitoring device providing the unique features of the invention is provided as part of each data storage system; and

FIG. 3 is a flow chart illustrating functions performed by a storage monitoring system, such as the system shown in FIG. 1, to classify the type of organized data structure implemented by a host in a data storage system or device, to analyze the resulting mapped data structure, and to report the results of the analysis to the host or other requesting entity.

### DETAILED DESCRIPTION OF THE PREFERRED EMBODIMENTS

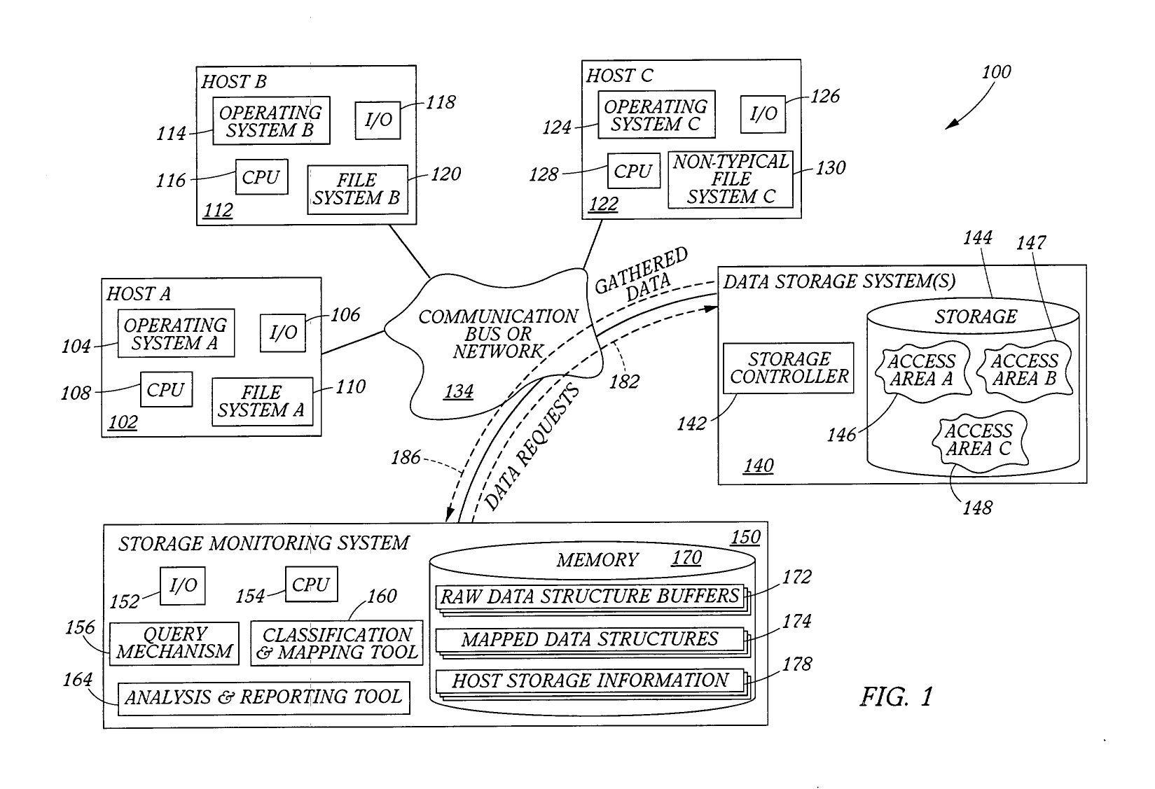

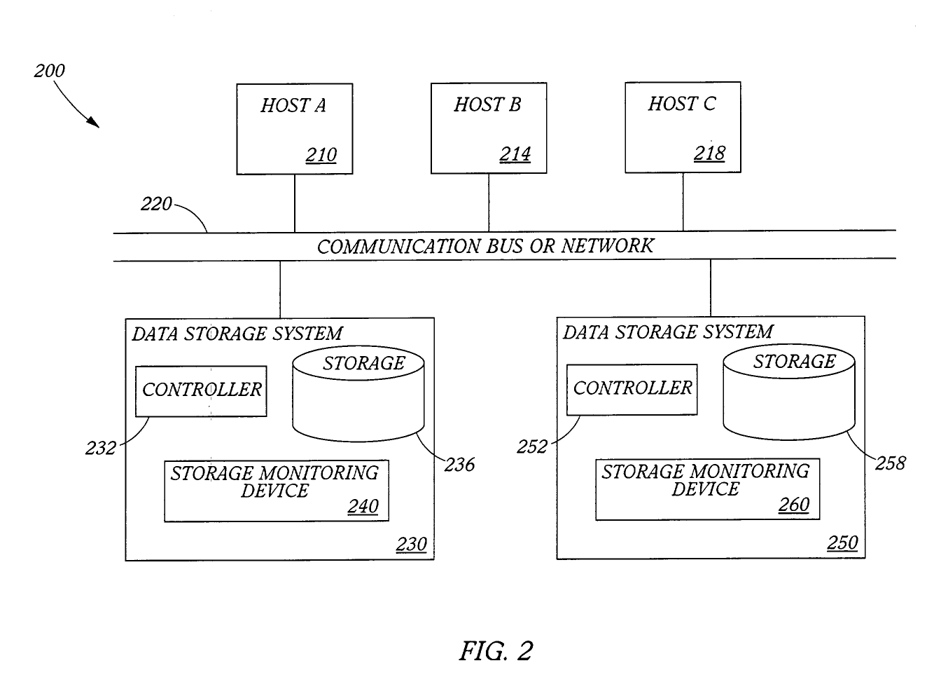

In general, the present invention is directed to a method and system for characterizing or classifying the type of organized data structures used by computing devices in storing data in a data storage device and using that classification to analyze the computing devices' data storage information (such as storage capacity usage, number of files, and the like). In a simple example of the invention, a computing device (e.g., a host computer) is connected to a disk array or other data storage device. During operations, the computing device is granted access to a specific area or areas of the data storage device. In one embodiment, the specific access areas are referred to or identified by logical identification numbers (LUNs) or other device identifiers. The host creates a file system or other organized data structure that allows abstracted access to the disk array storage device. A second computing device (such as a query system or a storage monitoring system as shown in FIG. 1), either externally (as a discrete computer) or internally (as part of the data storage device as shown in FIG. 2) is attached or communicatively linked to the disk array storage device and allowed access to the same area(s) as the host. The query system reads the area(s) and interprets the stored organized data structure.

The query system uses a low-level read or an operating system call to retrieve data from the specific access area(s) or LUN(s). The data retrieved from the LUN(s) is then analyzed to determine what file system has been created. By understanding what organized data structure exists in the specific access area(s), the query system can then read and interpret information including, but not limited to, disk capacity, disk free space, location, number of files, and other data structure information. Significantly, from a query server (e.g., a computing device that may or may not own or control the organized data structure), the system of the invention is able to read data and interpret the read data for the purpose of determining data storage usage statistics. Hence, the data gathering system and method of the present invention is particularly useful for performing non-intrusive monitoring of a data storage customer's assets, which is a product and/or service that will be readily adapted and demanded by the data storage industry.

FIG. 1 illustrates a data storage information gathering system 100 in which the features of the present invention is implemented. As will be understood, the present invention can be utilized in numerous computer networks or systems in which data is stored locally or, more commonly, in data storage devices that are linked to computing devices by communication busses or networks, such Intranets, the Internet, and others. The specific hardware devices used for host devices, the communication network, the storage monitoring system, and data storage system are not considered limiting and, hence, are described mainly in terms of their functions rather than a particular device.

As illustrated, three host devices (i.e., Host A, Host B, and Host C) 102, 112, 122 are linked or attached to a data storage system (or systems) 140 via a communication bus or network 134. The hosts 102, 112, 122 may be any computing device, such as an application server, that processes data and stores data in and retrieves data from storage system 140. The hosts 102, 112, 122 include CPUs or processors 108, 116, 128 for operating software or human instructions and controlling data flow to and from the hosts 102, 112, 122 and I/O devices 106, 118, 126 for communicating with other devices in the system 100 over the network 134. As noted previously, the specific CPU and I/O devices selected for the hosts 102, 112, 122 may vary widely and typically, may be any of numerous devices readily available and often implemented in the data storage industry.

Each host 102, 112, 122 includes an operating system 104, 114, 124 that manages hardware and software resources in the hosts 102, 112, 122 and specific to this invention, the operating systems 104, 114, 124 manage data storage for applications and/or software on the hosts 102, 112, 122 or clients accessing the hosts 102, 112, 122. The operating systems 104, 114, 124 may be the same systems or may differ and may be any operating system that may be used in hosts 102, 112, 122. For example, but not as a limitation, the operating systems 104, 114, 124 may be Unix™, OS/2 from IBM, Linux, Solaris™ from Sun Microsystems, Inc., DOS or Windows™ from Microsoft Corporation, or other operating systems.

Operating systems 104, 114 utilize file systems 110, 120 to manage online storage space available in the data storage system 140. Generally, the file systems 110, 120 act to store data (or allocate data storage) in data storage system 140 in organized data structures (or file systems), with the configuration of such data structures varying with the particular file system used for systems 110, 120. In operation, when operating systems 104, 114 are different the file systems 110, 120 will often be different, e.g., a Unix™ operating system may utilize a different file system than a Windows™ operating system. As will become clear, the invention is useful for identifying or classifying numerous file system types including, but not limited to, versions of NTFS, UFS, EXT, FAT, VXFS, JFS, and other useful file systems.

Host 122, in contrast, utilizes a non-typical file system 130 for managing storage of data in the data storage system 140. In this application, “non-typical” file systems are those data allocation devices that arrange stored data in organized data structures that do not correspond to standard file system methods. For example, the non-typical file system 130 may be a database management system (or corresponding storage management devices) that acts to store data as a database in the data storage system 140. Such non-typical file systems useful for non-typical file system 130 include those provided by Oracle, Informix, Sybase, and Microsoft (e.g., MS SQL Server). The use of data storage system 140 will differ for host 122 based on the use of the non-typical file system 130, and the system 100 is uniquely adapted to identify the non-typical file system 130 and to analyze host 122 data storage usage statistics and information based on this identification.

The system 100 is particularly well-suited for configuration as a storage network, such as a storage area network (SANs), configured to use Fibre Channel (or other interconnect technologies such as Ethernet, Infiniband, iSCSI, and the like) as the fabric or network 134 linking host devices or servers 102, 112, 122 to SAN-attached storage devices, storage controllers, and appliances in system 140. In this regard, terminology useful with Fibre Channel fabrics is in one embodiment but this is not a limitation as the features of the invention may be performed with numerous interconnect technologies and network configurations. Additionally, any of a number of standard and well-known I/O interfaces 106, 118, 126 in hosts 102, 112, 126 and data communication protocols may be utilized to practice the invention, such as those that move block data over networks such as FCP for FC (Fibre Channel), SRP for IB (InfiniBand) and other block data protocols and networking infrastructures, which are particularly useful in presenting remote, and often pooled, storage to the client (or host) as if it were local storage at the client.

The data storage system 140 may be a single data storage device or a network of storage devices (such as SAN, NAS, and the like) to provide online storage to the hosts 102, 112, 122. In the simplified embodiment of FIG. 1, the data storage system 140, includes a storage controller 142 (such as an array controller) that controls access to storage 144. For example, the storage controller 142 communicates with hosts 102, 112, 122 and grants access or permission to select access areas of the storage 144, as shown by access areas 146, 147, 148 that are labeled to correspond to a specific host device 102, 112, 122. The storage 144 may include tape libraries, disks, disk arrays, and other useful data storage devices arranged in a variety of configurations, such as volumes in RAID devices. In one embodiment, the storage 144 comprises disks and access areas 146, 147, 148 comprise one or more LUN (logical unit number), which is an identification number given to devices (such as devices connected to an SCSI adapter) useful for locating storage devices and data stored upon that device. The system 100 is useful for determining the operating parameters or characteristics of the storage 144 and for reporting this information in a useful form to the hosts 102, 112, 122 or operators of such devices.

According to an important aspect of the invention, a storage monitoring system 150 (e.g., one or more computing devices) is connected to the data storage system 140 and hosts 102, 112, 122 via network 134. The storage monitoring system 150 includes an I/O device 152 functioning to communicate digital information over the network 134 and a CPU 154 for processing instructions from a query mechanism 156, a classification and mapping tool 160, and an analysis and reporting tool 164 to manage storage and retrieval of data from memory 170 (which may be local or remote to system 150). The query mechanism 156, classification tool 160, and analysis tool 164 may be embodied in software routines, applications, objects, and the like written or coded in any useful programming language and run on system 150. Firmware or other devices may further be included in the system 150 to handle specific data architectures, such as the inclusion of a distributed data management (DDM) device (e.g., a DDM Source) for supporting switch-based DDM by working with the other mechanisms of the system 150 to retrieve data and transmit commands to a DDM target on data storage system 140.

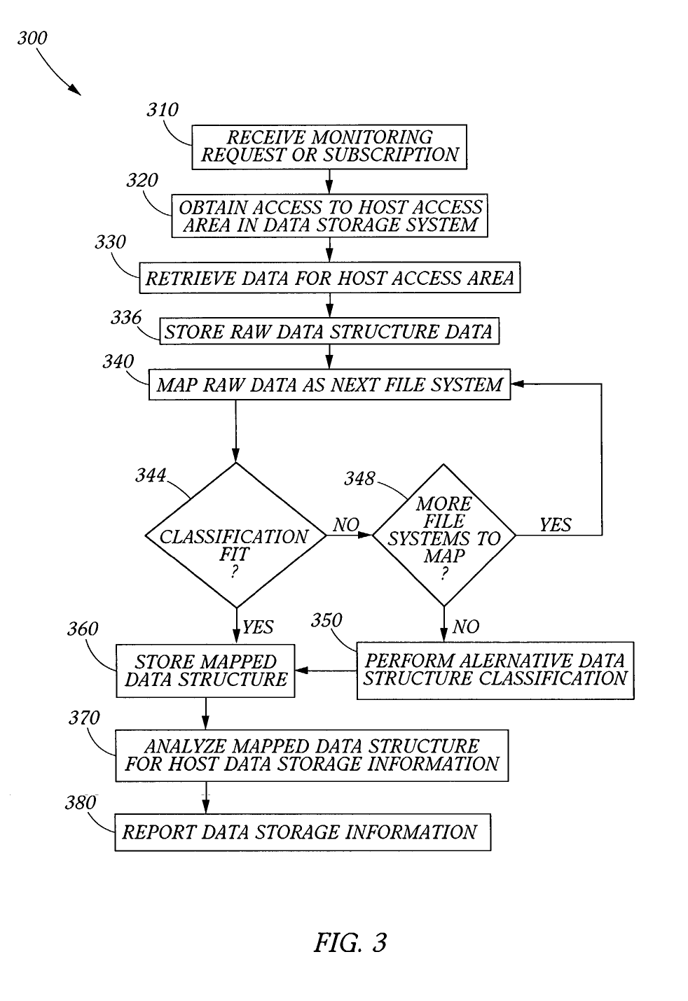

The function of the storage monitoring system 150 will be discussed in detail with reference to FIG. 3, but, briefly, the query mechanism 156 acts to transmit data requests 182 (such as low level reads or operating system calls) to the storage controller 142. The storage controller 142 grants the storage monitoring system 150 access to the appropriate access area or specific access area 146, 147, or 148 and raw data is read. The gathered data 186 is transferred over the network 134 back to the storage monitoring system 150 for storage in raw data structure buffers 172. The classification and mapping tool 160 then acts to process the raw data in buffers 172 to determine the type of organized data structure (such as a particular file system or non-typical file system) and to map the raw data to the appropriate data structure that is stored at 174 in memory 170. The analysis and reporting tool 164 is provided to analyze the mapped information 174 to determine useful data storage information (such as number and location of files, disk capacity, available disk space, and the like) and to then report the information to a requesting customer (such as an operator of a host 102, 112, 122 or the data storage system 140).

In FIG. 1, the storage monitoring system 150 is provided as a separate device in a distributed network or in a closely linked network. However, the features of the invention may also be provided within a data storage system. In FIG. 2, a number of hosts 210, 214, 218 are linked via communication bus or network 220 to a pair of data storage systems 230, 250. Each data storage system 230, 250 includes a controller or processor 232, 252 and storage 236, 258 (such as disks, disk arrays, tape libraries, or combinations thereof). In each data storage system 230, 250, a storage monitoring device 240, 260 is provided to provide the data gathering/accessing, the raw data analysis to classify the data structure and map the raw data, the analysis of the mapped data to determine host data storage usage information, and to report such determined information. While shown as a separate device, the functions of the devices 240, 260 may be incorporated into the functioning of the controllers 232, 252 to practice the invention.

FIG. 3 illustrates exemplary processes that are performed during operation of the data gathering system 100 of FIG. 1 to provide enhanced, non-intrusive monitoring and management of data storage by a client or host devices. Significantly, the data gathering and analysis method 300 does not require intimate knowledge of the operating systems 104, 114, 124 and file systems 110, 120, 130 to provide characterize and analyze the data storage usage of the hosts 102, 112, 122. The method 300 begins with the installation of the storage monitoring system 150. At this point, a relationship is established with the data storage system 140 such that the storage controller 140 responds to data requests 182 by the storage monitoring system 150 by providing at least limited access to the storage 144 (e.g., read-only access to access areas 146, 147, 148 for which the storage controller 142 is able to verify that permission has been granted by hosts 102, 112, 122 for system 150 to read stored data). Although not discussed in detail herein, security measures may be implemented in some embodiments to have storage controller 140 verify the identity of the storage monitoring system 150 prior to providing access or read-only permission to storage 144 and, of course, in embodiments where the storage monitoring system 150 owns the storage 144 added security would not be an issue.

At the beginning or initialization stages of the process 300, the storage monitoring system 150 may present or advertise its storage management and monitoring services over the network 134 to all devices (such as hosts 102, 112, 122). At 310, the storage monitoring system 150 receives a monitoring request or subscription for services from one of the hosts 102, 112, 122 (or another device or operator managing the hosts 102, 112, 122). A file may be created to identify network addresses and other information (such as security information for use in obtaining access permission from storage controller) for each host 102, 112, 122 that subscribes to the monitoring services and stored in memory 170 for use in reporting usage information.

At 320, the query mechanism 156 contacts the data storage system 140 (or systems) that is being used by the host identified in the monitoring request and requests permission to access the access area 146, 147, or 148 coinciding with specific access area(s) granted by the storage controller 142 to the identified host device 102, 112, or 122. Typically, the storage controller 142 grants the query mechanism non-intrusive access (such as read-only access that does not interfere with data storage operations of the identified host 102, 112, or 122) but in some cases, intrusive access may be granted and used by the query mechanism, such as temporarily blocking access to the storage 144 by the affected host 102, 112, or 122.

At 330, the query mechanism 156 operates to retrieve data for the identified host from the host access area 146, 147, or 148. Although other techniques may be used, a preferred query mechanism 156 utilizes low-level reads and/or operating system calls as part of the data requests 182 to retrieve or read data from the specific access area(s) 146, 147, 148 (e.g., from specific LUNs used by the identified host 102, 112, 122), with the read data being organized in an organized data structure. The read or gathered data is returned over the network 134 as indicated by arrow 186. The CPU 154 and/or query mechanism 156 stores the gathered data 186 in memory 170 in raw data structure buffers 172 for later processing.

The data gathering and analysis process 300 then begins the important function of classifying the raw data structure information in buffers 172 as a known file system type or non-typical (but known) data structure or file system type. Classifying raw data structures as to type can be accomplished in many ways with the following description intended to only be illustrative of one useful technique that can be used to practice the invention. At 340, the classification and mapping tool 160 processes the data in buffers 172 to recast or “map” the data as or into a known file system selected from a group of known file systems stored in memory and including but not limited to NTFS4, NTFS5, UFS, EXT2, FAT32, FAT16, VXFS, JFS, or other systems in use by the data storage industry. At 344, the classification and mapping tool 160 determines if a match or classification fit is achieved with the present file system mapping. In other words, the tool 160 decides if the raw data in buffers 172 can be fit into the current file system.

If a match is not achieved at 344, the tool 160 determines if there are additional file systems in memory 170 that should be analyzed for a classification fit or match. If there are more file systems, step 340 is repeated for the next file system and at 344, another determination is made for a classification fit. These steps 340, 344 are repeated until a match is obtained or until all file systems have been examined for a match. The specific order in which file systems are tried at 340 can be varied but will typically be selected to provide an initial guess as to which file systems are more likely to be used by hosts 102, 112, 122 (such as by market share, by knowledge of the system 100 in which the storage monitoring system 150 is installed, and other useful prediction factors).

If at 348 no more file systems are left to be tested, the classification and mapping tool 160 attempts to map the raw data structure to a set of known non-typical data structures or file systems that may be utilized by hosts 102, 112, 122, such as a database system provided by Oracle, Microsoft, Informix, Sybase, or other vendors. If automated classification is not possible at 350, a forced classification method can be completed based on knowledge obtained through other mechanisms. For example, the identified host 102, 112, 122 can be contacted or queried to obtain the type of non-typical file system utilized or this information can be obtained as part of the initial subscription or monitoring request and the information simply retrieved from memory 170 at this point in the process 300. With knowledge of the particular system being used by the host 102, 112, 122, the classification and mapping tool 160 can complete mapping of the raw data in buffers 172 onto the now known data structure and the process 300 can continue at 360 with storing of the mapped data structure 174 in memory 170.

At 344, if a classification fit or match is indicated, processing 300 can continue at 360 with storage of the correctly mapped data structure 174 in memory 170. Alternatively or optionally, additional probing may be performed at 344 to verify that a classification fit has actually occurred. This extra probing or testing may involve checking known fields in the particular data structure (built according to a particular file system) for known or expected values (sometimes referred to as magic numbers). Most if not all file systems will have at least a few fixed or known values for data in certain fields that can be found in any organized data structure built by that file system. Hence, raw data structure information read from the storage 144 should have these expected or magic numbers when a match is found at 344. This second check of the classification leads to increased accuracy in mapping by the tool 160.

At 370, the analysis and reporting tool 164 processes the mapped data structures 174 to determine a number of data usage parameters or values that are then stored as host storage information 178 in memory 170. At 380, the analysis and reporting tool 164 processes the host storage information 178 for reporting to the requesting entity (such as a host 102, 112, 122 or managing or operating device (not shown)), and the reporting may be performed online with messages, reports, and/or real time GUI interactions or offline with a hard or soft copy being delivered to the requesting entity.

The analysis at 370 is made efficient and effective by the previous mapping step 340 as the tool 164 can now readily identify relevant pieces of the data structure knowing the correct file system or non-typical file system. The analysis 370 may include interpreting such information as disk capacity, disk free space, location of data, number of files, and other data structure and data storage usage information. In one embodiment, the analysis 370 involves determining the total number of data blocks contained in the mapped data structure 174, and then determining the total number of blocks that are presently in use by the host 102, 112, 122 that owns the data structure 174 in data storage system 140. In some cases, the analysis 370 further includes determining the number of files contained in the mapped data structure 174 and then identifying the location of each of these files in the storage 144 and calculating the size of individual files in the mapped structure 174. Further, the analysis 370 sometimes includes reading and determining the contents of individual files contained in the structure 174. Of course, the analysis 370 may involve additional information determination or gathering steps to collect information useful in monitoring and managing data usage by a host 102, 112, 122.

A version of the mapping algorithm or method 300 has been successfully implemented on a standard Fibre Channel attached to a Windows™ PC. The software (e.g., query mechanism 156) issued low level reads to the Fibre Channel attached storage device (similar to system 140 and, in the test case, an EMC Symmetrix, an EMC Clarion, local IDE and SCSI disk to the Windows™ PC, and a Hitachi 7700E disk array although other hardware and software devices may readily be utilized to practice the invention). Once the relevant blocks (e.g., gathered data 186) were returned from the storage device, the lab implementation of the computer system (e.g., classification and mapping tool 160 of system 100) classified the blocks, as in classification step 340 of FIG. 3, to determine, from the host's perspective, the names of the file systems or partitions or table names, the size of said file systems, partitions or tables, and the used and unused portions of the file systems, partitions, or tables (as in step 370 performed by the analysis and reporting tool 164). The lab implementation of the computer system also successfully classified NTFS 4 and 5, FAT16, FAT32, UFS, EXT2 and VXFS. This testing shows that the features of the above-described system and method are useful as a product/service to perform non-intrusive monitoring of customer assets that would most likely be readily accepted and demanded by the data storage industry.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method for monitoring and characterizing data storage use by a host device in a data storage system that provides the host device an access area within a storage device for storing data, comprising:
obtaining access to the host device access area in the storage device;
retrieving raw data structure data from the host device access area;
classifying the raw data structure data as a type of structure defined by one of a predefined set of file systems; and
determining a set of host storage information from the raw data structure data based on the classifying.

2. The method of claim 1, wherein the classifying includes a first mapping of the raw data structure data to an organized data structure based on a first one of the file systems and verifying a classification match by determining whether the mapped organized data structure is formed properly according to the first file system.

3. The method of claim 2, wherein the verifying includes identifying a set of expected values for an organized data structure formed based on the first file system and comparing at least one of the expected values to an actual mapped value in the mapped organized data structure.

4. The method of claim 2, wherein the classifying includes, when a classification match is not verified, a second mapping of the raw data structure data to an organized data structure based on a second one of the file systems and repeating the verifying of the classification match.

5. The method of claim 4, wherein the classifying includes repeating the mapping of the raw data structure data and classification match verifying for all the file systems or until the verifying is successfully completed.

6. The method of claim 1, wherein the classifying includes classifying the raw data structure as a type of structure defined by a non-typical file system.

7. The method of claim 6, wherein the non-typical classifying included retrieving non-typical file system identification information and mapping the raw data structure to an organized data structure based on the retrieved identification information.

8. The method of claim 1, wherein the accessing of the markup language document includes parsing with a first or a second parser and further including selecting the first or the second parser based on the database language statement.

9. The method of claim 1, wherein the host storage information includes at least one data storage characteristic selected from the group consisting of number of data blocks, number of the data blocks in use, storage capacity, storage free space, number of files, location of files, size of individual files, and contents of the individual files.

10. The method of claim 1, further including generating a report including at least a portion of the determined host storage information.

11. The method of claim 1, wherein the retrieving includes using a low-level read or an operating system call to retrieve the raw data structure data.

12. A computer system for monitoring use of a data storage device, comprising:
a query component that obtains access from a controller of the data storage device to a specific access area in storage on the data storage device used by a host device for storing data and that retrieves data from the access area; and
a classification component that processes the retrieved data to determine a file system used in allocating the retrieved data as an organized data structure in the access area.

13. The system of claim 12, further including an analysis component for processing the retrieved data based on the determined file system to determine one or more elements of host storage information defining usage of the access area by the host device.

14. The system of claim 13, wherein the host storage information elements are selected from the group consisting of number of data blocks, number of the data blocks in use, storage capacity, storage free space, number of files, location of files, size of individual files, and contents of the individual files.

15. The system of claim 12, wherein the query component uses a low-level read or an operating system call to retrieve the data from the access area.

16. The system of claim 12, wherein the classification component further functions to map the retrieved data to a structure defined by a first file system and to verify the mapped structure complies with a structure format for the first file system as part of the determining.

17. The system of claim 16, wherein the classification component repeats the mapping of retrieved data for additional ones of the file systems when the mapped structure cannot be verified.

18. The system of claim 12, wherein the file system is a non-typical file system and the classification component functions to map the retrieved data to an organized data structure defined by the non-typical file system.

19. The system of claim 12, wherein the query component and classification component are included in the data storage device.

20. A method for characterizing data storage use by a computer device in a data storage system that provides the computer device a device-specific access area within storage for storing data allocated as an organized data structure, comprising:
obtaining access to the device-specific access area in the storage;
retrieving raw data from the device-specific access area;
using one file system from a set of file systems to map the raw data to a data structure based on the one file system; and determining a set of host storage information from the mapped data structure.

21. The method of claim 20, further including prior to the determining, verifying the mapped data structure matches an organized data structure form defined by the one file system and when verifying fails, repeating the using with a second file system from the set of file systems.

22. The method of claim 21, wherein the mapped data structure is a database.
